(19) United States
(12) Patent Application Publication
(10) Pub. No.: US 2016/0110811 A1
(43) Pub. Date: Apr. 21, 2016

(54) Methods and Apparatus for Implementing Improved Notional-free Asset Liquidity Rules

(71) Applicants: Frank Pak-Ho Siu, Happy Valley (HK); Anthony A. Renshaw, New York, NY (US)

(72) Inventors: Frank Pak-Ho Siu, Happy Valley (HK); Anthony A. Renshaw, New York, NY (US)

(73) Assignee: AXIOMA, INC., New York, NY (US)

(21) Appl. No.: 14/519,991

(22) Filed: Oct. 21, 2014

(51) Int. Cl. G06Q 40/06; G06Q 40/04

(52) U.S. Cl. CPC G06Q 40/06; G06Q 40/04

(57) ABSTRACT

On the basis of simulated backtests, many portfolios including so-called smart beta and other factor products often boast impressive track records. However, given the additional trading that occurs, can such advertised performance truly be realized once transaction costs are taken into account? One might expect these products to make a concerted effort to manage liquidity. However, explicit efforts to manage liquidity in existing smart beta and factor ETF and index products have been relatively modest. A new set of rules are provided that are independent of the notional value of the portfolio that can be used to better manage the liquidity of investment portfolio.

### FIELD OF INVENTION

The present invention relates to improved methods for constructing investment portfolios and indexes while managing the liquidity of the individual holdings and trades. More particularly, it relates to improved computer based systems, methods and software for managing the liquidity of investment portfolios and indexes.

### BACKGROUND OF THE INVENTION

Although often overlooked, today's historically low trading costs are one important driver in the emergence of “smart beta” and other factor products. Unlike cap-weighted products that require trading only to handle corporate actions, universe reconstitution, and fund cash flows, smart beta products require periodic rebalancing, that is, trading, to maintain their mandated characteristics. Their current popularity is only possible because trading costs have become low enough that smart beta performance can realistically compensate for the additional trading costs inherent to non-cap-weighting. Managing liquidity is therefore crucial to capturing smart beta or factor performance.

On the basis of simulated backtests, smart beta and other factor products often boast impressive track records. However, given the additional trading that occurs, can such advertised performance truly be realized once transaction costs are taken into account? One might expect these products to make a concerted effort to manage liquidity. However, explicit efforts to manage liquidity in existing smart beta and factor ETF and index products have been modest and not sufficiently fine-tuned.

In one common approach, which is referred to herein as “universe-driven liquidity”, the trading costs and liquidity are managed solely by the choice of the universe of investible assets. An example of a universe-driven product is the PowerShares S&P 500 Low Volatility ETF (SPLV), which invests in the 100 assets from the Standard & Poor's (S&P) 500 with the lowest, realized annual volatility. All assets in the S&P 500 are assumed to be sufficiently liquid that the fund executes whatever trades are needed at each rebalance to buy and hold the 100 assets with the lowest volatility.

A second, common approach to managing liquidity, which is referred to herein as “trading-driven liquidity”, is to explicitly restrict trading at each rebalance, typically by limiting the turnover. Examples of trading-driven liquidity ETFs include the iShares MSCI USA Minimum Volatility ETF (USMV) where round trip turnover is limited to 20% at each rebalance and the SPDR Russell 1000® Low Volatility ETF (LGLV) where round trip turnover is limited to 12% at each rebalance.

Until recently, there were very few ETFs that employed “asset-driven liquidity” construction rules, that is rules the limited the holdings or trades in individual assets so as to specifically improve the liquidity of the ETF. Asset liquidity rules are important because even if a portfolio has very low turnover, the small turnover can still result in trading illiquid assets. The presence of illiquid assets is not the problem per se. The problem to be avoided is having to hold or trade them in large amounts.

In traditional portfolio construction, as opposed to the construction of factor ETF and index products, asset liquidity is managed by comparing each asset's trade or holdings to its average daily volume (ADV). ADV measures the amount of an asset that is traded on a given day, and can be measured in units of currency or shares. Often, ADV is reported as an average value over a fixed number of days. For example, the twenty-day average ADV is the average volume traded each day over the preceding twenty days. There are other liquidity metrics as well. For intra-day trading, the volume varies during the day, so trading volume depends on whether it is close to the open or close of the trading day or in the middle of the day.

In traditional portfolio construction, if the notional value of the portfolio is N dollars, then the dollar amount held in the i-th asset is (N wᵢ), where wᵢ is the weight held in the i-th asset. If trading rules allow the trading of at most a fraction c of the ADV traded in dollars of the i-th asset, denoted by ADVᵢ, then the number of days needed to liquidate the i-th holding is (N wᵢ)/(c ADVᵢ). This relationship leads to the well-known constraint

$$\frac{{Nw}_{i}}{c {ADV}_{i}} \leq Z for each asset i \qquad ( 1 )$$

for each asset, i, and some constant Z representing the days it would take to liquidate the holdings in that asset.

Although this type of constraint is popular and a standard feature in commercial portfolio construction tools such as Axioma Portfolio™, it has not been considered an attractive liquidity rule for an ETF or index fund because there is no good way to estimate what the notional value, N, might be. Unlike hedge funds, ETFs and other smart beta products must publish their portfolio construction methodology so that potential investors can understand the product. It is possible, but onerous to change any published methodology, so every attempt is made to make the methodology as insensitive to time and events as possible. ETF and index construction rules based on a notional value of the product would be unattractive, since the hope is that the notional value will increase substantially over time.

A simple asset-based liquidity constraint that has been used for ETFs and indexes is to exclude names with an ADV less than some prescribed amount:

Hold Only If ADVᵢ,>ADV_{MIN}, i=1, . . . ,K. (2)

ADV_{MIN} can be specified in terms of currency, local or numeraire, or shares, or cut offs in both currency and shares can be used. When this constraint is used, there are no limitations on how large the holdings may be for assets with ADVᵢ,>ADV_{MIN} and, in fact, the holdings or trades for asset with ADV slightly greater than ADV_{MIN} may be quite illiquid. In other words, the constraint (2) still permits illiquid positions and trades.

Another simple asset-based constraint that can be used to manage liquidity in a coarse way involves limiting the asset holdings with respect to a benchmark. With the benchmark weights denoted as bᵢ, the weight of each holding can be limited to be at most a constant λ times its weight in the benchmark using the equation

wᵢ<λbᵢ, i=1, . . . ,K (3)

where λ is a constant to be determined and λ>1 is required for the solution to be feasible. This constraint can be applied even if no ADV information is available. But, of course, since the constraint is independent of ADV, it does not directly manage or limit the liquidity of the individual asset positions or trades. If an asset has a small benchmark weight but a large ADV, then the constraint (3) may incorrectly manage liquidity.

MSCI's Minimum Volatility Indices Methodology, available at http://www.msci.com/eqb/methodology/meth_docs/MSCI_Minimum_Volatility_Methodology_Jan12.pdf, published January 2012, which is incorporated by reference herein in its entirety, applies a variation of this constraint in which the maximum asset weight is the lower of 1.5% or 20 times the weight in the benchmark.

By way of background, there are three topics closely related to the present invention: portfolio construction using optimization, factor risk models, and factor indexes. The following discussion reviews aspects of the prior art in each of these areas.

Optimization techniques are frequently used to construct a portfolio of holdings for a universe or set of potential investment opportunities or assets. For example, the stocks comprising the Russell 1000 index represent a universe of U.S. large cap stocks. The stocks comprising the Russell 2000 index represent a universe of U.S. small cap stocks.

Optimization has a long history in portfolio construction, including the construction of factor indexes. Mean-variance portfolio optimization was first described by H. Markowitz, “Portfolio Selection”, Journal of Finance 7(1), pp. 77-91, 1952 which is incorporated by reference herein in its entirety. In mean-variance optimization, a portfolio is constructed that minimizes the risk of the portfolio while achieving a minimum acceptable level of return. Alternatively, the level of return is maximized subject to a maximum allowable portfolio risk. The family of portfolio solutions solving these optimization problems for different values of either minimum acceptable return or maximum allowable risk is said to form an “efficient frontier”, which is often depicted graphically on a plot of risk versus return. There are numerous, well known, variations of mean-variance portfolio optimization that are used for portfolio construction. These variations include methods based on utility functions, Sharpe ratio, and value-at-risk.

A portfolio construction strategy is a set of rules defining an optimization problem that will be used to construct a portfolio of investment allocations from a universe of potential investments. The portfolio construction strategy or rules comprises two elements. The first element is an objective function, which is a set of weighted terms to be either maximized or minimized. For example, if there is an expected return or alpha signal, that is generally one term of the objective function. If there is a risk or variance estimate, that can be another term. Similarly, transaction costs, the cost of shorting assets, if allowed, and the expected taxable gains, can also be terms in the objective function.

The second element of the portfolio construction strategy is a list of constraints that the portfolio allocation must satisfy. For example, constraints can be placed on the asset holdings, such as a minimum of 0% for long-only holdings, or a maximum of 10% of the total portfolio value. Industry exposures, sector exposures, country exposures, and other factor exposures can be imposed on the portfolio. The turnover of the portfolio, defined as the sum of the absolute value of the trades, can also be constrained to be less than a fixed amount. These types of constraints are linear bounds on the portfolio holdings which can be readily solved using modern computer optimization software. The ease of use and intuitive simplicity of these constraints account for their popularity. Indeed, virtually all commercial portfolio optimization software allows a portfolio manager to impose these kinds of constraints. For example, Axioma sells a portfolio optimization software under the name Axioma Portfolio™ software with such functionality.

The asset liquidity constraints shown in equations (1), (2) and (3) are all linear constraints on the asset weight.

Constraints can also be placed on the maximum allowable risk or active risk, also called tracking error, the maximum number of names held, and so forth. Because some of these types of constraints are combinatorial, for example, maximum number of names held, they are mathematically challenging to impose and solve. Nevertheless, commercially available software includes these kinds of constraints as well.

A crucial issue for these optimization techniques is how sensitive the constructed portfolios are to changes in the estimates of risk and return. Small changes in the estimates of risk and return occur when these quantities are re-estimated at different time periods. They also occur when the raw data underlying the estimates is corrected or when the estimation method itself is modified. Mean-variance optimal portfolios are known to be sensitive to small changes in the estimated asset return, variances, and covariances. See, for example, J. D. Jobson, and B. Korkei, “Putting Markowitz Theory to Work”, Journal of Portfolio Management, Vol. 7, pp. 70-74, 1981 and R. O. Michaud, “The Markowitz Optimization Enigma: Is Optimized Optimal?”, Financial Analyst Journal, 1989, Vol. 45, pp. 31-42, 1989 and Efficient Asset Management: A Practical Guide to Stock Portfolio Optimization and Asset Allocation, Harvard Business School Press, 1998, (the two Michaud publications are hence referred to collectively as “Michaud”) all of which are incorporated by reference herein in their entirety.

A number of procedures have been proposed to alleviate the sensitivity of optimized portfolios to changes or errors in the input data. The most common approach is to add constraints to the optimization problem that restrict the range of possible portfolio holdings.

More recently, mathematical techniques in robust optimization have been used to explicitly model and compensate for estimation error in portfolio risk and, where appropriate, return. The upside of robust portfolio optimization is that large arbitrage-like bets that are sensitive to model parameters can be avoided. The downside is that too much conservativeness leaves real opportunities unexploited.

Robust portfolios are constructed by solving a quadratic min-max problem with quadratic constraints. Technical details for solving such problems are given in A. Ben-Tal, and A. Nemirovski, “Robust Convex Optimization”, Mathematics of Operations Research, Vol. 23, pp. 769-805, 1998, which is incorporated by reference herein in its entirety. Robust optimization techniques have been applied to financial problems by M. S. Lobo, “Robust and Convex Optimization with Applications in Finance”, Stanford University dissertation, 2000, and D. Goldfarb, and G. lyengar, “Robust Portfolio Selection Problems”, Mathematics of Operations Research, Vol. 28, pp. 1-37, 2003, both of which are incorporated by reference herein in their entirety.

U.S. Pat. Nos. 7,698,202 and 8,315,936 describe techniques in which an additional risk factor is added to a portfolio construction strategy to improve the performance of the optimized portfolios, and are incorporated by reference herein in their entirety. The document “Refining Portfolio Construction When Alphas and Risk Factors are Misaligned” by J. Bender, J.-H. Lee, and D. Stefek, MSCI Barra Research Insight, March 2009, available at http://www.mscibarra.com/research/articles/2009/RI_Refining_Port_Construction.pdf describes a technique in which the objective function of a portfolio optimization problem is modified by a penalty. This document is incorporated by reference herein in its entirety.

Portfolio construction using optimization techniques often makes use of an estimate of portfolio risk, and some approaches make use of an estimate of portfolio return, also called alpha. Alpha and risk terms can appear in either the objective function or the list of constraints.

The most common method for estimating the risk of a portfolio is to use a factor risk model. A factor risk model comprises an asset return model

r=Bf+ε

and a corresponding factor risk model

Q=BΣB^{T}+Δ

where

r is a K dimensional vector of asset excess returns (return above the risk free rate)

B is a K by M matrix of factor exposures (also called factor loadings)

f is an M dimensional vector of factor returns

ε is a K dimensional vector of asset specific returns (also called residual returns)

Q is a K by K matrix of asset covariances=Cov(r, r)

Σ is an M by M matrix of factor covariances=Cov(f, f)

Δ is a K by K matrix of security specific covariances=Cov(ε, ε); often, Δ is taken to be a diagonal matrix of security specific variances. In other words, the off-diagonal elements of Δ are often neglected, for example, assumed to be vanishingly small and therefore not explicitly computed or used.

In general, the number of factors, M, is much less than the number of securities or assets, K.

If the vector of portfolio weights is denoted by w, then the predicted variance of the portfolio is given by the matrix product w^{T} Q w, where the superscript T indicates the vector transpose. The risk of the portfolio is the square root of its variance. The active risk or tracking error is derived using the same formula but replacing the portfolio weight vector with the difference of the vector of portfolio weights and the vector of benchmark weights.

The covariance and variance estimates in the matrix of factor-factor covariances, Σ, and the (possibly) diagonal matrix of security specific covariances, Δ, are estimated using a set of historical estimates of factor returns and asset specific returns.

Both the covariance and variance computations may utilize techniques to improve the estimates. For example, it is common to use exponential weighting when computing the covariance and variance. Such weighting is described in R. Litterman, Modern Investment Management: An Equilibrium Approach, John Wiley and Sons, Inc., Hoboken, N. J., 2003, which is incorporated by reference herein in its entirety. It is also described in R. C. Grinold, and R. N. Kahn, Active Portfolio Management: A Quantitative Approach for Providing Superior Returns and Controlling Risk, Second Edition, McGraw-Hill, New York, 2000, which is incorporated by reference herein in its entirety. U.S. Patent Application Publication No. 2004/0078319 A1 by Madhavan et al. also describes aspects of factor risk model estimation and is incorporated by reference herein in its entirety.

The covariance and variance estimates may also incorporate corrections to account for the different times at which assets are traded across the globe. For example, U.S. Pat. No. 8,533,107 describes a returns-timing correction for factor and specific returns and is incorporated by reference herein in its entirety.

The covariance and variance estimates may also incorporate corrections to make the estimates more responsive and accurate. For example, U.S. Pat. No. 8,700,516 describes a dynamic volatility correction for computing covariances and variances, and is incorporated by reference herein in its entirety.

Traditionally, commercial factor risk models come in three varieties: fundamental factor risk models, statistical factor risk models, and macroeconomic factor risk models.

In fundamental factor risk models, the factor exposures are defined using explicit market and security information. Typically, fundamental factor risk models include Style factors which measure the exposure or loading of each security to factors such as value, growth, leverage, size, momentum, volatility, and so on. The exposures are often given as Z scores, in which the raw measurements of these metrics has been normalized by subtracting off the cap-weighted mean value and dividing the results by the equal-weighted standard deviation of the original measurements. See Litterman for further details. By performing this resealing, a factor such as size, measured as market cap, with values such as billions of dollars, can be meaningfully compared to a factor such as volatility, measured in terms of annual volatility, which is usually a number less than one. In Axioma's U.S. Equity Medium Horizon, Fundamental Factor Risk Model, there are eleven style factors: dividend yield, exchange rate sensitivity, growth, leverage, liquidity, market sensitivity, medium-term momentum, return-on-equity, size, value, and volatility.

Fundamental factor risk models also include categorical factors such as industries, countries, market, and currency factors. In binary models, such as those sold by Axioma, the exposure of any security is non-zero and equal to one for only one industry, one country and one currency. Other commercial factor risk model vendors sometimes spread out the exposure of an individual security across more than one categorical factor in each of these categories, with the restriction that the total exposure across each category adds up to 100%. So, for instance, General Electric may have non-zero exposure to both health and finance industries.

Other categorical assignments can be used as well. For instance, the global industry classification standard (GICS) taxonomy developed by MSCI and Standard & Poor's has four classification levels: industry sub-groups; industries; industry groups, and sectors. Countries can be grouped by region, for example, Americas, Europe, Asia, or by economy, for example, developed or emerging.

Once the factor exposures have been defined, the factor returns for a fundamental factor risk model are estimated using a cross-sectional regression across the security returns at any point in time.

In statistical factor risk models, the matrix of security returns across the universe of securities and back through time is analyzed to determined factors that best represent the volatility of returns. Often principal components analysis is used to determine these factors. By construction, statistical factors are highly representative of the risk of the assets. However, since the exposures are determined mathematically, it is often difficult to develop intuition about what each statistical factor may mean in terms of traditional metrics such as size and value. Furthermore, since the factors can change from day to day, any intuition developed on one day for a particular model may not be applicable on another day.

In macroeconomic factor risk models, the factors are chosen to represent the correlation or beta of each security to a time series of macroeconomic data such as GDP, interest rates, corporate spreads, and the like.

A fourth category of factor risk models is a hybrid factor risk model, which mixes elements of the fundamental, statistical and macroeconomic factor risk models. For example, in G. Miller, “Needles, Haystacks, and Hidden Factors,” Journal of Portfolio Management, vol. 32(2), pp. 25-32, 2006, which is incorporated by reference herein in its entirety, a two pass approach is described for estimating a factor risk model. In the first pass, fundamental factor exposures are calculated based on historical data, and then the factor returns to these fundamental factors are estimated using cross-sectional regression. Then, rather than taking the residual returns of this process and using them to compute the specific variances, a set of statistical factor exposures are computed to describe these residual returns. Then, the residuals of this second pass are used to compute the specific variances. The idea is that the second statistical pass can find important factors for describing the asset returns that may have been over-looked by the set of fundamental factors. The two passes result in a “hybrid” factor risk model in that it includes both fundamental and statistical risk factors.

Commercial factor risk models have been available for over three decades and have been extensively used both simply to report risk and also in conjunction with optimization and portfolio construction strategies that require risk elements or exposure elements. Extensive research has been performed to determine high quality factors to use in a risk model.

Over the last five years, there has been an explosion of ETFs offering a wide selection of affordable “factor” exposures, including the Russell-Axioma Factor ETFs and PowerShares ETFs. These factor ETFs have also been called “smart beta” products. The factors selected—volatility, beta and momentum, among others—are often a subset of the “style risk factors” used by commercial equity fundamental factor risk models. These factors are known to explain risk since they are commonly used in factor risk models. Several of these factors have been also closely associated with highly successful hedge funds, so the implication is that these factors are also potential alpha signals. There are numerous other possible factors. U.S. Pat. No. 7,620,577 lists a number of these: market price, market capitalization, book value, sales, revenue, earnings, earnings per share, income, income growth rate, dividends, dividends per share, earnings before interest, tax, depreciation and amortization, and the like. This patent is incorporated by reference herein in its entirety.

Regardless of whether or not the target factor of a factor index is also a factor in a factor risk model, factor indexes can be used as investment tools in various ways. For instance, indexes comprising a plurality of securities can often be bought and sold more cheaply than buying and selling the individual constituents of the index. This approach allows investment in these securities with reduced transaction costs. In passive and enhanced indexing, investments are made with reference to an index or benchmark portfolio. A benchmark portfolio is a portfolio intended to represent the market in general. The holdings of a benchmark portfolio are often proportional to the market capitalization of each security. Performance statistics such as return and risk are reported with respect to the reference index or benchmark portfolio. Indexes can serve as active manager benchmarks or the underlyers for investable products such as ETFs and mutual funds.

The present invention addresses managing the liquidity of individual assets in factor indexes. In particular, it describes a set of rules for managing the liquidity of individual assets in factor indexes in a manner that is independent of the notional value of the portfolio to be constructed. This independence is an important characteristic since there is no good way to estimate the notional value for many factor indexes and ETFs but the rules for their construction must be published and followed.

### SUMMARY OF THE INVENTION

On the basis of simulated backtests, many portfolios including so-called smart beta and other factor products often boast impressive track records. Among its several aspects, the present invention recognizes that given the trading required for these products, such performance often cannot be realized once transaction costs are taken into account. For example, many portfolio construction rules or strategies create portfolios that take illiquid positions that are costly to trade into and out of. Such illiquid positions are undesirable, as the trading costs hurt the performance of the portfolio.

The present invention also recognizes that efforts to manage liquidity in existing smart beta and factor ETF and index products have been modest and that the existing approaches for managing liquidity are not adequate for many investment portfolio products such as smart beta ETFs. Many ETFs constrain the over-all trading of the portfolio at each rebalance with a turnover constraint. Low turnover, however, does not always prevent the portfolio construction process from taking illiquid positions. Existing asset level liquidity constraints based on ADV such as that shown in equation (1) require a notional value for the portfolio so that the amount held or traded in each asset can be reasonably compared to its ADV. The need for a notional value for the portfolio is a major limitation to existing approaches that is overcome by one aspect of the present invention.

One aspect of the present invention provides a new set of procedures that can be used to manage the liquidity of investment portfolios. The procedures are independent of the notional value of the portfolio and are therefore appropriate for index and ETF products for which there may be no good estimate of the notional value.

One goal of the present invention, then, is to provide an alternative approach to managing asset liquidity in portfolio construction. Instead of requiring a notional value to set the dollar value held or traded in each asset, the present invention makes a notional-free evaluation of the liquidity of the portfolio. In one embodiment of the invention, the weighted average liquidation time of the portfolio is limited to a maximum value of a constant times the weighted average liquidation time of a benchmark. This constraint can be formulated without knowing the notional value of the portfolio.

In a second embodiment of the present invention, the liquidity of each individual asset is compared to a limit based on a statistic of ADV such as the median ADV. Both embodiments successfully reduce the likelihood of portfolio construction rules from taking illiquid positions while minimally impacting the performance, for example, realized return and risk, of the portfolio.

Another goal is to provide a method and system for managing asset liquidity that is attractive to ETF and Index construction.

A more complete understanding of the present invention, as well as further features and advantages of the invention, will be apparent from the following Detailed Description and the accompanying drawings.

### BRIEF DESCRIPTION OF THE DRAWINGS

FIG. 1 shows a computer based system which may be suitably utilized to implement the present invention;

FIG. 2 illustrates summary statistics for an initial backtest for a first case study;

FIGS. 3A and 3B (referred to herein collectively as FIG. 3) are graphs illustrating the distribution of assets held and asset liquidity for the first case study;

FIG. 4 illustrates a comparison of several measures of liquidity for the first case study;

FIG. 5 illustrates the realized return and risk frontier for the first case study for different parameters using four different approaches to manage liquidity;

FIG. 6 illustrates the realized Sharpe ratio as a function of the maximum, normalized asset liquidation time for the first case study for different parameters using four different approaches to manage liquidity;

FIG. 7 illustrates the realized Sharpe ratio as a function of the normalized weighted average portfolio liquidation time for the first case study for different parameters using four different approaches to manage liquidity;

FIG. 8 illustrates the realized Sharpe ratio as a function of the number of names held for the first case study for different parameters using four different approaches to manage liquidity;

FIG. 9 illustrates the realized Sharpe ratio as a function of the average portfolio turnover for the first case study for different parameters using four different approaches to manage liquidity;

FIG. 10 illustrates the realized Sharpe ratio as a function of the average predicted beta for the first case study for different parameters using four different approaches to manage liquidity;

FIG. 11 illustrates a comparison of liquidity for five different portfolios for the first case study;

FIG. 12 illustrates summary statistics for the initial backtest for a second case study;

FIG. 13 illustrates the realized return and risk frontier for the second case study for different parameters using four different approaches to manage liquidity;

FIG. 14 illustrates the realized Sharpe ratio as a function of the maximum, normalized asset liquidation time for the second case study for different parameters using four different approaches to manage liquidity;

FIG. 15 illustrates the realized Sharpe ratio as a function of the normalized weighted average portfolio liquidation time for the second case study for different parameters using four different approaches to manage liquidity;

FIG. 16 illustrates the realized Sharpe ratio as a function of the number of names held for the second case study for different parameters using four different approaches to manage liquidity;

FIG. 17 illustrates the realized Sharpe ratio as a function of the average portfolio turnover for the second case study for different parameters using four different approaches to manage liquidity;

FIG. 18 illustrates the realized Sharpe ratio as a function of the average predicted beta for the second case study for different parameters using four different approaches to manage liquidity;

FIG. 19 illustrates a universe of assets together with a benchmark weight, an alpha score, and ADV to be used in a simple liquidity management example;

FIG. 20 illustrates the factor exposures to be used in a liquidity management example;

FIG. 21 illustrates the specific risk vector to be used in a liquidity management example;

FIG. 22 illustrates the factor-factor covariance matrix in percent squared units to be used in a liquidity management example;

FIG. 23 illustrates the factor return vector to be used in a liquidity management example;

FIG. 24 illustrates an initial portfolio construction for the liquidity management example;

FIG. 25 illustrates a second portfolio construction incorporating liquidity rules for the liquidity management example;

FIG. 26 illustrates a third portfolio construction incorporating liquidity rules for the liquidity management example;

FIG. 27 illustrates a flow chart of the steps of a process in accordance with an embodiment of the present invention; and

FIG. 28 illustrates a second flow chart of the steps of a process in accordance with a further embodiment of the present invention.

### DETAILED DESCRIPTION

Recently, the present inventors worked with Stoxx to apply the concepts of the present invention to introduce a set of minimum variance indexes that incorporated a liquidity constraint on the portfolio that was independent of the notional value of the portfolio. This approach is described in Stoxx Index Methodology Guide (portfolio Based Indices), http://www.stoxx.com/download/indices/rulebooks/stoxx_indexguide.pdf, Chapter 16.1, published August 2014, which is incorporated by reference herein in its entirety. Instead of measuring liquidity with respect to the notional value of the portfolio, in this new approach, the weighted average liquidation time of the portfolio or a subset of the portfolio was limited with respect to the weighted average liquidation time of the benchmark. Numerous backtests and studies confirmed that this form of constraint successfully reduced the likelihood that portfolio construction methodology would result in taking illiquid positions.

The novelty of this approach underscores how scarce the existing research is on asset liquidity constraints for portfolio construction apart from notional-based rules such as equation (1) above. The present invention addresses this scarcity as addressed below.

The present invention may be suitably implemented as a computer based system, in computer software which is stored in a non-transitory manner and which may suitably reside on computer readable media, such as solid state storage devices, such as RAM, ROM, or the like, magnetic storage devices such as a hard disk or solid state drive, optical storage devices, such as CD-ROM, CD-RW, DVD, Blue Ray Disc or the like, or as methods implemented by such systems and software. The present invention may be implemented on personal computers, workstations, computer servers or mobile devices such as cell phones, tablets, IPads™, IPods™ and the like.

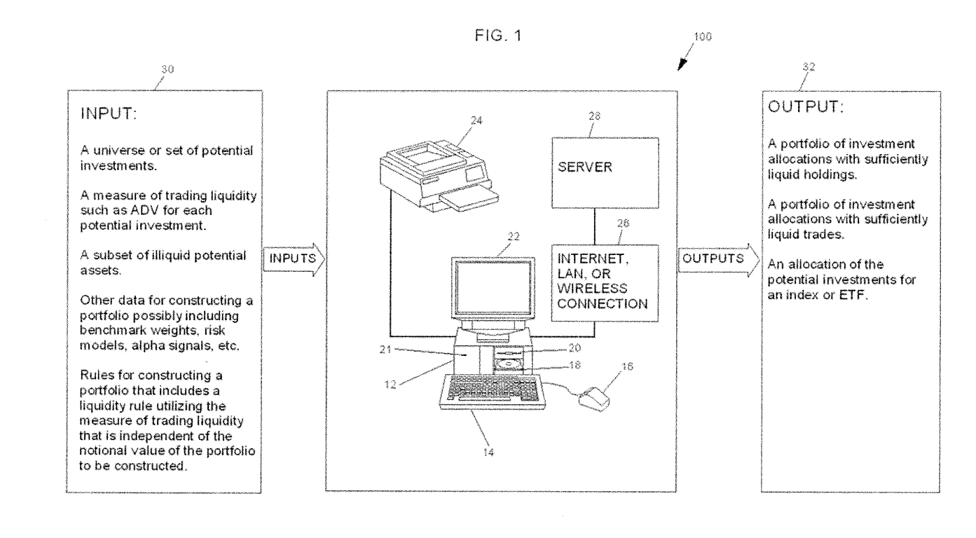

FIG. 1 shows a block diagram of a computer system 100 which may be suitably used to implement the present invention. System 100 is implemented as a computer or mobile device 12 including one or more programmed processors, such as a personal computer, workstation, or server. One likely scenario is that the system of the invention will be implemented as a personal computer or workstation which connects to a server 28 or other computer through an Internet, local area network (LAN) or wireless connection 26. In this embodiment, both the computer or mobile device 12 and server 28 run software that when executed enables the user to input instructions and calculations on the computer or mobile device 12, send the input for conversion to output at the server 28, and then display the output on a display, such as display 22, or print the output, using a printer, such as printer 24, connected to the computer or mobile device 12. The output could also be sent electronically through the Internet, LAN, or wireless connection 26. In another embodiment of the invention, the entire software is installed and runs on the computer or mobile device 12, and the Internet connection 26 and server 28 are not needed.

As shown in FIG. 1 and described in further detail below, the system 100 includes software that is run by the central processing unit of the computer or mobile device 12. The computer or mobile device 12 may suitably include a number of standard input and output devices, including a keyboard 14, a mouse 16, CD-ROM/CD-RW/DVD drive 18, disk drive or solid state drive 20, monitor 22, and printer 24. The computer or mobile device 12 may also have a USB connection 21 which allows external hard drives, flash drives and other devices to be connected to the computer or mobile device 12 and used when utilizing the invention. It will be appreciated, in light of the present description of the invention, that the present invention may be practiced in any of a number of different computing environments without departing from the spirit of the invention. For example, the system 100 may be implemented in a network configuration with individual workstations connected to a server. Also, other input and output devices may be used, as desired. For example, a remote user could access the server with a desktop computer, a laptop utilizing the Internet or with a wireless handheld device such as cell phones, tablets and e-readers such as an IPad™, IPhone™, IPod™, Blackberry™, Treo™, or the like.

One embodiment of the invention has been designed for use on a stand-alone personal computer running Windows 7. Another embodiment of the invention has been designed to run on a Linux-based server system. The present invention may be coded in a suitable programming language or programming environment such as Java, C++, Excel, R, Matlab, Python, or the like.

According to one aspect of the invention, it is contemplated that the computer or mobile device 12 will be operated by a user in an office, business, trading floor, classroom, or home setting.

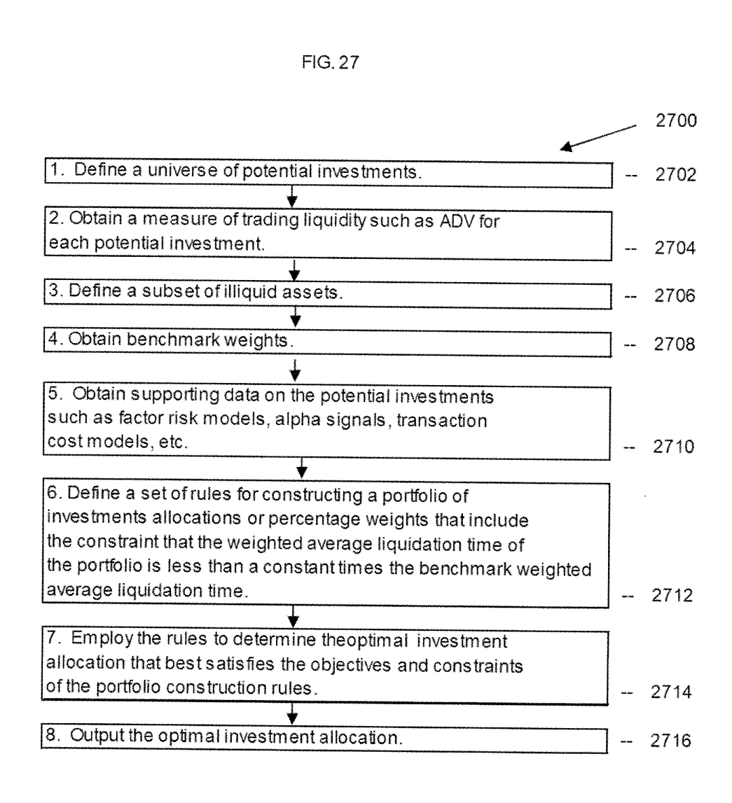

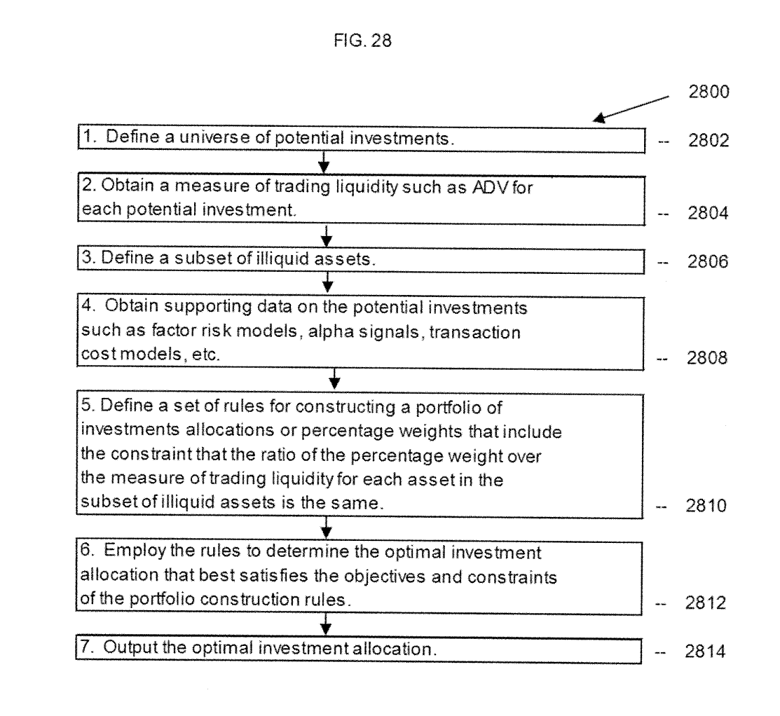

As illustrated in FIG. 1, and as described in greater detail below, the inputs 30 may suitably include a universe or set of potential investments, a measure of trading liquidity such as ADV for each potential investment, a subset of illiquid potential assets, other data for constructing a portfolio possibly including benchmark weights, risk models, alpha signals, etc., and rules for constructing a portfolio that includes a liquidity rule utilizing the measure of trading liquidity that is independent of the notional value of the portfolio to be constructed as further described below, and particularly in the discussion of equations (5), (6), (7) and (8), and in connection with FIGS. 27 and 28.

As further illustrated in FIG. 1, and as described in greater detail below, the system outputs 32 may suitably include a portfolio of investment allocations with sufficiently liquid holdings, a portfolio of investment allocations with sufficiently liquid trades, and an allocation of the potential investments for an index or ETF.

The output information may appear on a display screen of the monitor 22 or may also be printed out at the printer 24. The output information may also be electronically sent to an intermediary for interpretation. For example, the performance attribution results for many portfolios can be aggregated for multiple portfolio reporting. Other devices and techniques may be used to provide outputs, as desired.

With this background in mind, a detailed discussion of the invention and its context follow below. The liquidity issues occurring in smart beta products are first illustrated using a prototypical portfolio construction example. A minimum risk portfolio is constructed using the assets in the Russell 1000 Index, an index of approximately 1000 large capitalization, U.S. equities, using the following portfolio construction rules:
Rebalance monthly from Dec. 31, 2001 to Mar. 30, 2014 (150 rebalancings).
Assets held must belong to the Russell 1000 Index as of that date.
Minimize the total risk of the portfolio as predicted by Axioma's Fundamental Factor, Medium Horizon, U.S. Equity risk model (AXUS3-MH).
Long only, with maximum asset weight of 10%.
Maximum round-trip turnover of 10%. This constraint is placed in Axioma's Constraint Hierarchy in case of infeasibility as occurs on some dates when the underlying benchmark is reconstituted. The first rebalancing is from cash and has a turnover of 100%.
Do not hold assets with a twenty-day average daily volume (ADV) less than $1,000 US dollars.
Minimum non-zero holding size of 0.03%.

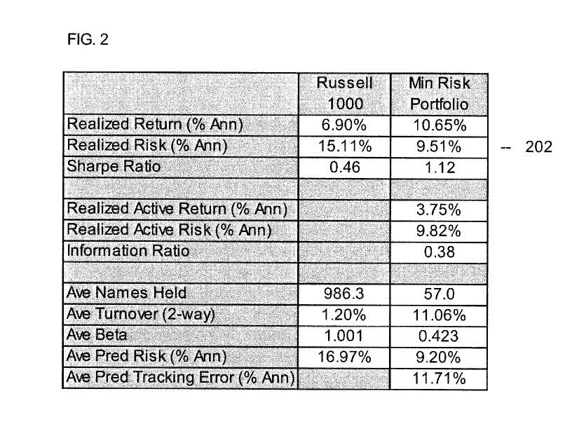

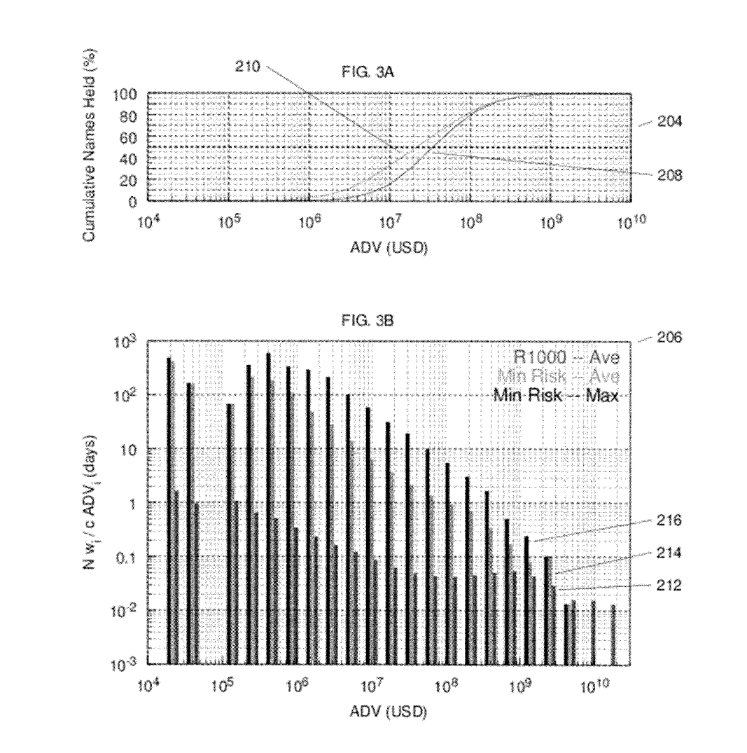

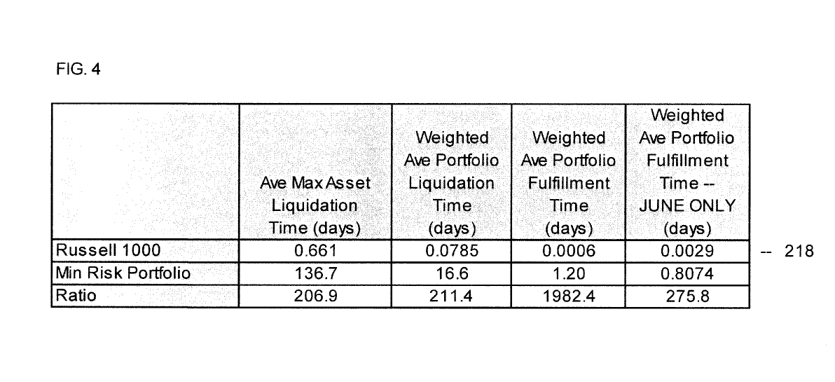

Table 202 in FIG. 2 shows summary statistics for this optimized minimum risk portfolio case study. The performance of the minimum risk portfolio is, on paper, substantial. The annualized return is 50% greater than the benchmark (10.65% vs. 6.90%) while the annualized realized risk is less than 65% of the benchmark (15.11% vs 9.51%), leading to a Sharpe ratio of 1.12, where the Sharpe ratio is the ratio of the annualized realized return over the annualized realized volatility. The benchmark holds substantially more names but has about a tenth as much turnover. FIG. 2 does not tell the whole story as discussed further below in connection with FIGS. 3 and 4.

Charts 204 and 206 in FIG. 3A and FIG. 3B show additional performance statistics for this first case study. Chart 204 shows the cumulative average names held and chart 206 shows the distribution of the asset liquidation time, (N wᵢ)/(c ADVᵢ), measured in days, as a function of ADV, in U.S. dollars (USD). The values N=$500 MM USD and c=10% were arbitrarily selected.

The charts 204 and 206 illustrate a number of important characteristics of liquidity. First, ADV ranges over more than five orders of magnitude. The distribution of ADV is strongly skewed to the right and has a long left tail.

Second, the “typical”, for example, median, names held have an ADV of approximately $30 MM. This can be seen in chart 204 where the curve 210 crosses the 50% value of the vertical axis. Curve 208 shows the cumulative names held for the benchmark, the Russell 1000 Index. Curve 210 shows the cumulative names held for the optimized portfolio. Less than 5% of the names held in the minimum risk portfolio had ADV less than one million US dollars ($1 MM). However, for the benchmark, 208, less than 5% of the names had ADV less than $3 MM. By construction, the benchmark holds all the names in the universe of potential investments. Therefore, the two curves 208 and 210, show that the minimum risk portfolio preferentially holds lower ADV names than the benchmark. This preference is a hallmark of a potentially illiquid portfolio, as there is much less and often more costly trading in low ADV stocks.

In chart 206, the asset liquidation times, (N wᵢ)/(c ADVᵢ), measured in days, have been grouped into ADV buckets, and the results are averaged over each of the 150 rebalancings. On the bar chart 206, the dark grey bars 212 on the right in each grouping of three bars represent the equi-weighted average asset liquidation time for all benchmark holdings for that ADV. The light grey bars 214 in the middle represent the average asset liquidation time for the minimum risk portfolio. The black bars 216 on the left show the maximum asset liquidation time for the minimum risk portfolio.

For the case shown, the most illiquid assets held in the minimum risk portfolio would take over 100 days to liquidate for the selected N and c of the example. This liquidation time is significantly larger than the most illiquid assets held in the benchmark value, which take about one day to liquidate. Note also that there are less than 5% of the names with ADV less than $1 MM. It is this small fraction of assets held that pose liquidity issues for this portfolio.

Another metric that is sometimes used to assess liquidity is the average liquidation time in days for an entire portfolio of K assets. Assuming the sum of the portfolio weights is one, the weighted average portfolio liquidation time is

$${\sum }_{i = 1}^{K} ( {w}_{i} ) ( \frac{{Nw}_{i}}{c {ADV}_{i}} ) \qquad ( 4 )$$

This average can be changed into average fulfillment times by replacing the term (N wᵢ) with (N|wᵢ−w_{OLD-i}|), where w_{OLD-i} is the portfolio weight before rebalancing.

Table 218 in FIG. 4 shows the average, across the time series of 150 rebalancings, maximum asset liquidation time in days for the Russell 1000 (0.66 days) and the minimum risk portfolio (136) days. The ratio of these two liquidation times is 207. Also shown are the average portfolio liquidation times and fulfillment times. The fulfillment times are also shown using just the numbers for the rebalancing at the end of June, which is when Russell performs its annual reconstitution of its indexes, which would be expected to be a more meaningful measure of the Russell 1000 fulfillment time.

The ratios are similar:
Maximum asset liquidation time=207.
Weighted portfolio liquidation time=211.
Weighted fulfillment time, June only=275.
   These ratios correspond approximately to the difference in the liquidity shown in chart 206 on the left of the chart, for example, the illiquid holdings, and serves as a good illustration of the relative illiquidity of the minimum risk portfolio.

The initial results for the first case study illustrated in FIGS. 3 and 4 strongly suggest that the minimum risk portfolio has liquidity issues since many of the positions taken would take significantly longer to liquidate than the corresponding positions in the benchmark.

Before proceeding to describe the present invention in detail, a few insights are noted.

First, in the analysis so far, arbitrarily chosen values for N and NI c have been employed. However, one of the insights of the present invention is the recognition that a statistic of ADV, such as its median, can be used to normalize the statistics and analysis, as ADV is independent of N as further described below in connection with constraint (5). The normalized liquidation and fulfillment times then no longer correspond to days to liquidate or fulfill a portfolio of size N but instead correspond to an imaginary portfolio of value equal to the median ADV. Regardless of the actual notional value of the portfolio to be constructed, the relative liquidity of the asset positions is the same regardless of whether or not N or median ADV is used. This idea is illustrated herein with the median value of ADV across all benchmark assets with non-zero ADV. It will be recognized by those skilled in the art that other statistics could be used. For instance, the median benchmark liquidity, defined as the ratio of the benchmark weight divided by the ADV of each asset, could also be used as further described below in connection with constraint (6).

Second, liquidity can be managed with respect to the portfolio holdings, wᵢ, or, alternatively, with respect to the rebalance trades, |wᵢ−w_{OLD-i}|. All constraints considered can be equally well formulated in terms of either holdings or trades. However, even though one might anticipate that managing trade liquidity would be more relevant and common, in fact, there is a bias towards managing holdings liquidity since this is the more conservative approach, as the trade is never larger than holdings. Nevertheless, even though the invention is illustrated using liquidity constraints in the context of holdings liquidity rather than trading liquidity, the results and conclusions apply equally well to trading liquidity constraints, and it should not be concluded that trading liquidity is less important than holding liquidity.

Third, in some of the liquidity constraints considered, the constraint is formulated with respect to a benchmark. Of course, a benchmark is not necessary to apply liquidity constraints. In fact, a benchmark may or may not be a good measure of liquidity. There are highly liquid benchmarks such as the S & P 500, and somewhat illiquid benchmarks such as the Russell 2000. The Russell 2000 is able to hold some hard to trade stocks because it is rebalanced only once a year. For most smart beta products, rebalancing is likely to occur more frequently, so the sensitivity to liquidity is likely to be more acute than in the benchmark.

Nevertheless, even if the underlying benchmark is not particularly liquid, formulating a liquidity constraint with respect to the benchmark is extremely convenient and easy to calibrate.

Fourth, almost all smart beta construction procedures manage turnover as an essential component in managing liquidity. Although it not emphasized here, that does not imply that turnover is not important. In many cases, the portfolio construction rules include trading limits such as a maximum turnover.

The present invention is now described in terms of two different constraints parameterized by the two constants β, and γ.

In the prior art, the most common liquidity constraint is to restrict each asset's liquidation time, ((N wᵢ)/(c ADVᵢ)) to be less than a fixed number of days. The present invention recognizes that other constraints can be advantageously used that are independent of N. In one embodiment according to the present invention each asset's liquidity is restricted by

$$\frac{{w}_{i}}{{ADV}_{i}} \leq \frac{β}{Median ( ADV )} , i = 1 , … , K \qquad ( 5 )$$

where β is a dimensionless constant to be determined as discussed further below. It will be recognized that other statistics of ADV besides the median ADV may be used. In the research studies performed, median ADV was as good as or better than any other statistic tested. Equation (5) represents one embodiment of the present invention.

A second embodiment of the present invention restricts the weighted average liquidation time of the portfolio to be less than a constant, γ, times the weighted average liquidation time of the benchmark.

$${\sum }_{i = 1}^{K} ( \frac{{w}_{i}^{2}}{{ADV}_{i}} ) \leq γ {\sum }_{i = 1}^{K} ( \frac{{b}_{i}^{2}}{{ADV}_{i}} ) \qquad ( 6 )$$

In equation (6), the summation is over all K assets in the universe. Equation (6) may also be applied to a subset of the universe of assets, in which case the summation will be over only the subset of assets to be included.

The two equations, (5) and (6), are illustrative of two preferred embodiments of the present invention. They do not require knowledge of the notional or cash value of the portfolio, the price of any assets or the number of shares held in each asset. These characteristics make them amenable to ETF and index construction rules. Furthermore, as is illustrated in the following detailed study, the constraints (5) and (6) are superior to the prior art constraints, such as constraints (2) and (3) in that they improve liquidity with less degradation in the backtest performance statistics. That is, for a given measure of liquidity, the return and Sharpe ratio of the backtest are higher and the risk is lower when using the constraints (5) and (6) than they are for the prior art constraints (2) and (3).

In addition, the two constants, β and γ, are dimensionless and easy to calibrate. In fact, the results presented here indicate that there are preferred ranges of these two parameters to more effectively improve liquidity with minimal degradation on performance. For the constraint (5), a preferred range is 0.0001<β<10. For values of β at and above 10, the constraint becomes too loose, and there are minimal improvements in liquidity. For β at and below 0.0001, the constraint is tight, and there are substantial improvements in liquidity, but also notable degradation in performance. A narrower preferred range is 0.001<β<0.1. For constraint (6), a preferred range is 0.5<γ<1000. A narrower preferred range is 2<γ<15.

Constraints (5) and (6) can be recast to constraint the liquidity of the trades rather than the holdings. For constraint (5), the trade liquidity constraint becomes

$$\frac{\vert {w}_{i} - {w}_{OLD - i} \vert}{{ADV}_{i}} \leq \frac{β}{Median ( ADV )} , i = 1 , … , K \qquad ( 7 )$$

While for constraint (6), the trade liquidity constraint becomes

$${\sum }_{i = 1}^{K} ( \frac{{w}_{i} \vert {w}_{i} - {w}_{OLD - i} \vert}{{ADV}_{i}} ) \leq γ {\sum }_{i = 1}^{K} ( \frac{{b}_{i}^{2}}{{ADV}_{i}} ) \qquad ( 8 )$$

In constraint (7), the comparison is still made to the benchmark holdings, but constraint (7) could also be formulated with respect to the benchmark trades as the upper bound on the constraint.

Next, the superiority of the constraints shown in equations (5) and (6) over the prior art constraints shown in (2) and (3) is illustrated by constructing frontier backtests over a range of values of the four constants AD V_{MIN}, λ, β, and γ. In each frontier backtest, the original portfolio construction strategy was used with the addition of one of either the two prior art constraints shown in equations (2) or (3) or the two constraints (5) or (6). For the prior art constraint (2), the range of the frontier backtest was $10⁵<ADV_{MIN}<$10⁹. For the prior art constraint (3), the range of the frontier was 10⁻¹<λ<10³. For the invention constraint (5), the range of the frontier was 10⁻⁴<β<10². For the invention constraint (6), the range of the frontier was 0.5<γ<5×10³. Note that these ranges are quite broad, ranging from values that make the constraints so loose they do not affect the solution at all to values that make the constraints so tight the constraint dominates the solution and severely degrades performance. In each case, the parameter range was divided into 80 logarithmically spaced points. For each of the 80 points, a backtest was then performed using that point as the parameter in the constraint. The aggregation of all 80 points taken in sequence then gives a frontier of performance statistics such as return, risk, and Sharpe ratio as the liquidity constraint ranges from loose to tight.

Next, charts are provided to illustrate that the invention constraints (5) and (6) are superior to the prior art constraints (2) and (3) in that, for a given level of liquidity, they have the least degradation of performance.

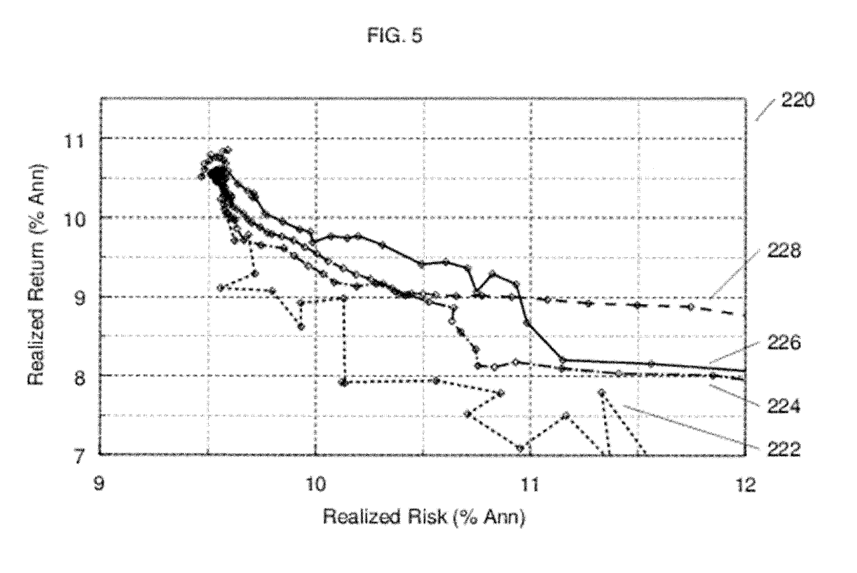

Chart 220 in FIG. 5 shows the traditional efficient frontier parameters, realized return and risk, for each of the four constraints: ADV_{MIN} is shown by the dotted curve 222; λ is shown by the dash-dot line 224; β is shown by the solid line 226; and γ is shown by the dashed line 228. At one end of the spectrum, illustrated by the top left of the chart in which all four curves converge, each of the constraints becomes less binding and the performance converges towards the unconstrained minimum risk portfolio results with the highest return and lowest risk. At the other end of the spectrum in the lower right of chart 220, each constraint becomes more binding, the return decreases, and the risk increases, although at different rates.

The ADV_{MIN} constraint has a notably non-smooth and non-monotonic frontier. In general, such behavior is undesirable. ADV_{MIN} is already frequently used but with very small values corresponding to the crowded points near the unconstrained performance results. It appears, however, that use of ADV_{MIN} with larger cut off values would not be recommended as the performance would be unstable to small perturbations in ADV_{MIN}.

For the other constraints, each of which is relatively smooth, β has the highest returns for the least constrained solutions, risk greater than 11%, while γ has the best returns for risk greater than 11%. The λ constraint has more performance degradation than either β or γ. Since it is anticipated that the best range of parameters to use these liquidity constraints will only perturb the original solution slightly, the β constraint appears to be the most effective for such small values.

Chart 220 illustrates a negative relationship between liquidity and the theoretical performance of minimum risk portfolios. Any constraint that improves liquidity decreases realized return and increases realized risk. This result underscores the importance of investigating the implementability of these portfolios in practice.

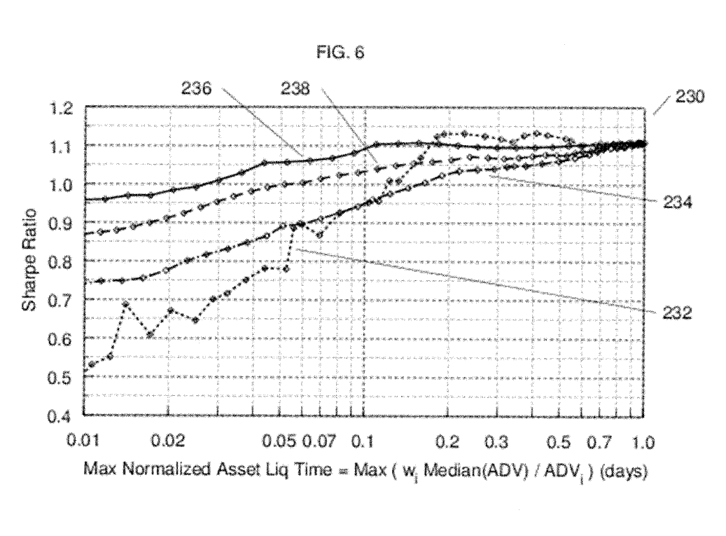

Chart 230 in FIG. 6 shows the Sharpe ratio, the ratio of annualized realized return over annualized realized risk, plotted against the maximum, normalized, asset liquidation time, (wᵢ Median (ADV))/(ADVᵢ), for each of the four constraints: ADV_{MIN} is shown by the dotted curve 232; λ is shown by the dash-dot line 234; β is shown by the solid line 236; and γ is shown by the dashed line 238. Once again, the β constraint has the most reduction in illiquidity with the least reduction in Sharpe ratio. The units of the horizontal axis are days, and the result can be interpreted as the number of days it would take to liquidate the most illiquid asset in the portfolio if the notional value of the portfolio where the median ADV and the participation rate, c, were 100%. Of course, it is unlikely and pure coincidence if the actual notional value of the portfolio would be the median ADV.

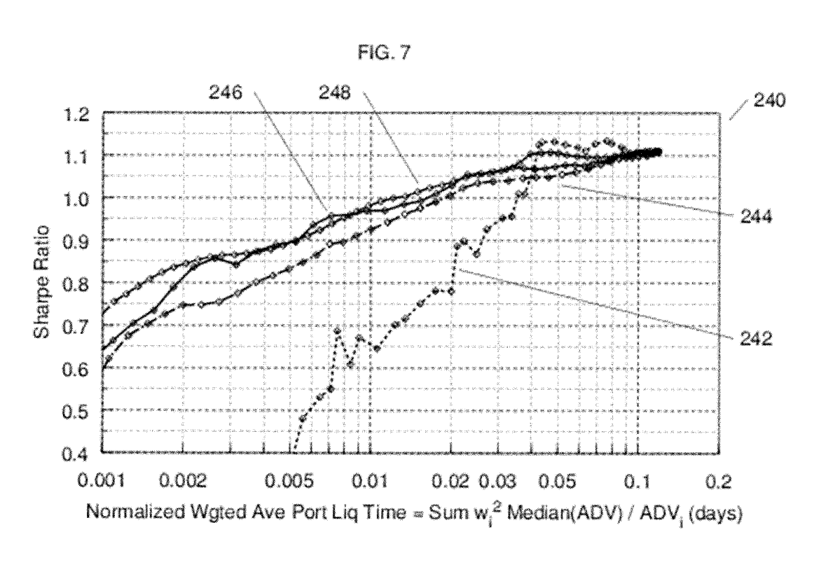

Chart 240 in FIG. 7 shows the Sharpe ratio plotted against the normalized, weighted average portfolio liquidation time,

$${\sum }_{i = 1}^{K} {w}_{i}^{2} Median ( ADV ) / {ADV}_{i} ,$$

for each of the four constraints: ADV_{MIN} is shown by the dotted curve 242; λ is shown by the dash-dot line 244; β is shown by the solid line 246; and γ is shown by the dashed line 248. Close to the original minimum risk solution in the upper right of the chart 240, the β constraint is most effective for portfolio liquidation time greater than 0.04. For more binding constraints, the β and γ constraints are essentially indistinguishable.

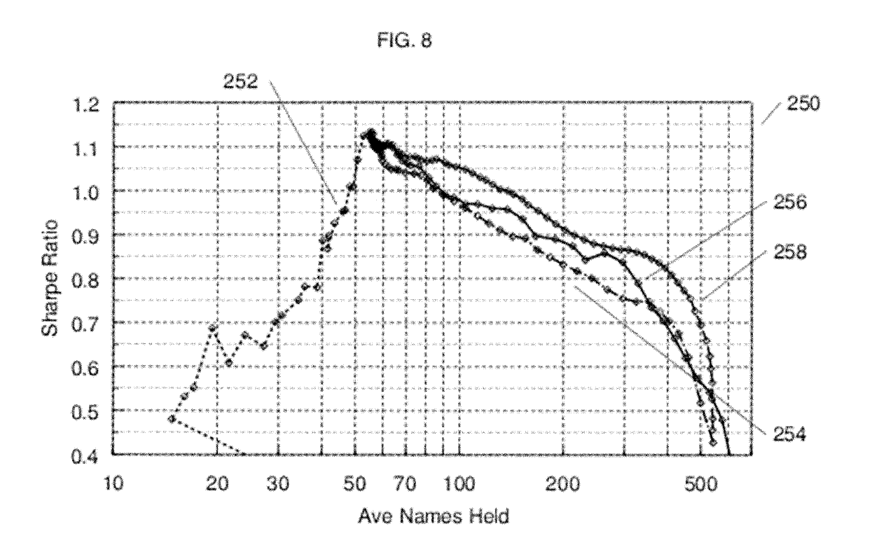

Chart 250 in FIG. 8 shows the Sharpe ratio plotted against the average number of names held for each of the four constraints: ADV_{MIN} is shown by the dotted curve 252; λ is shown by the dash-dot line 254; β is shown by the solid line 256; and γ is shown by the dashed line 258. If the portfolio is highly sensitive to the number of names held, it may make sense to manage liquidity with the ADV_{MIN} constraint. Otherwise, the constraint that increases the number of names held is γ, and the second most is β. However, since the horizontal axis is logarithmic, the difference in these two constraints is large. One should expect many more names when applying γ than in applying β. This result is not surprising since this constraint has a form very similar to a limit on the minimum number of effective names using the inverse Herfindahl Index.

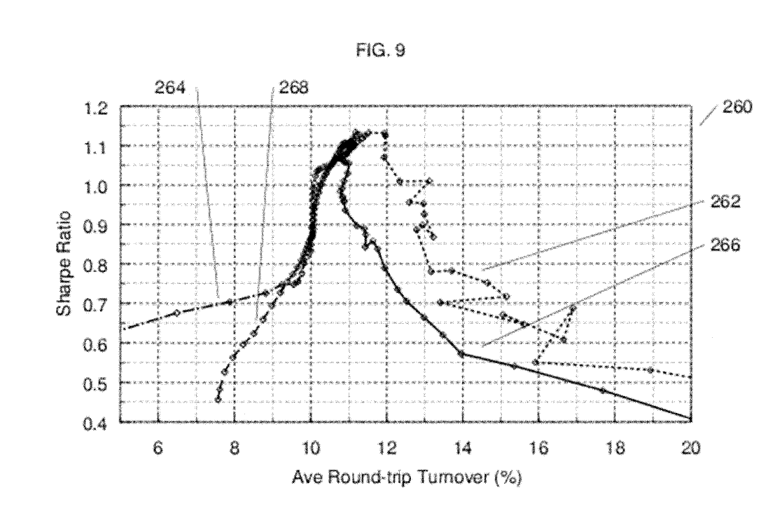

Chart 260 in FIG. 9 shows the Sharpe ratio plotted against the average two-way turnover for each of the four constraints: ADV_{MIN} is shown by the dotted curve 262; λ is shown by the dash-dot line 264; β is shown by the solid line 266; and γ is shown by the dashed line 268. Here a clear distinction is present between β, which generally increases turnover as it become more binding, and γ which generally decreases turnover as it becomes more binding.

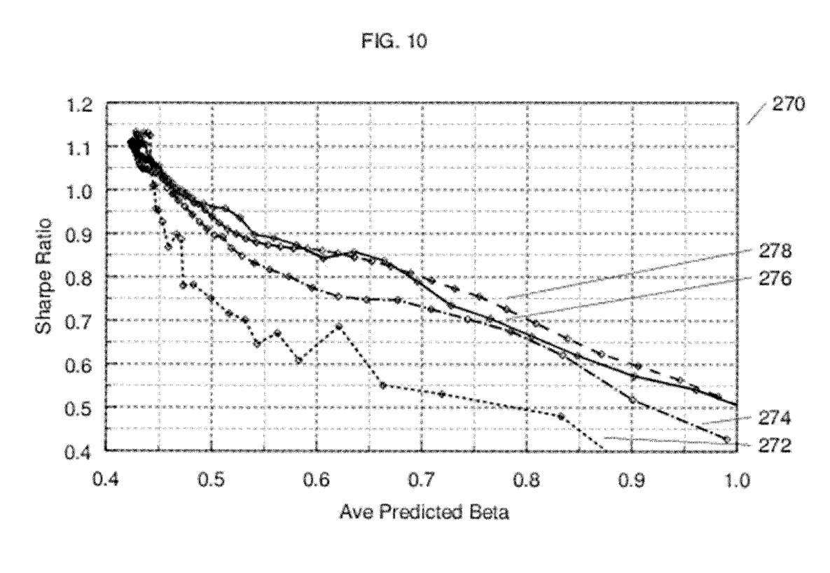

Finally, chart 270 in FIG. 10 shows the Sharpe ratio plotted against average predicted beta by Axioma medium horizon, fundamental factor U.S. equity risk model, AXUS3-MH, for each of the four constraints: ADV_{MIN} is shown by the dotted curve 272; λ is shown by the dash-dot line 274; β is shown by the solid line 276; and γ is shown by the dashed line 278. All constraints increase predicted beta as they become more binding, with β and γ having the most increase and generally being indistinguishable.

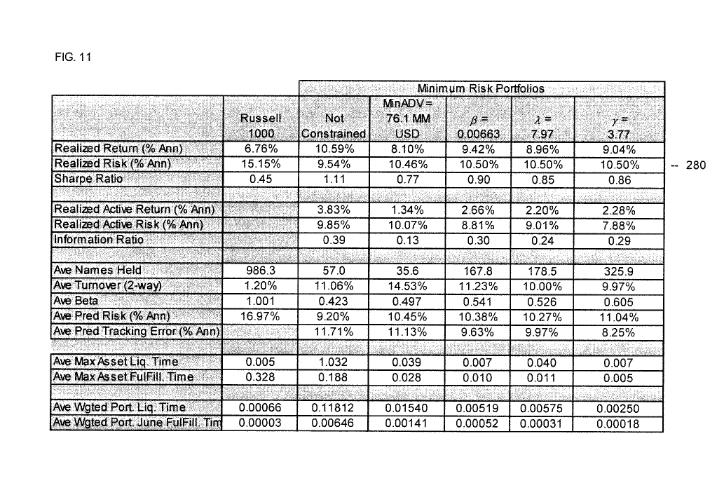

Table 280 in FIG. 11 shows the backtest performance statistics for the four different constraints with the parameter of each constraint chosen such that the realized risk is approximately 10.5%. This level of realized risk occurs for the particular parameter choices ADV_{MIN}=76.1 MM USD, β=0.00663, λ=7.67, and γ=3.77.

These results are consistent with the trends illustrated previously, specifically:
The non-smooth constraints, ADV_{MIN}, has the most error in matching the realized risk of 10.5%.
The largest return is for β (9.42%). For this particular set of parameters, β appears to be the most attractive constraint in many respects.
As expected, the number of names for γ (325) is much higher than any of the other constraints (133 to 178). Using γ may only be appropriate if the number of names can be large.
The increase in predicted beta is largest for γ (0.605).
The turnover changes are modest except for ADV_{MIN}.
As expected, β and γ have the shortest asset and portfolio liquidation times.

In order to test the generality of the results for the first case study, a second case study was performed with a different smart beta example. In this case, a value-momentum portfolio was constructed. The same portfolio construction strategy as before was used except instead of minimizing the risk of the portfolio, the tilt towards an alpha signal constructed by averaging the Value and Medium-term Momentum style factors from Axioma's Fundamental Factor risk model (AXUS3-MH) was maximized. As before, backtest frontiers were created by adding one of the constraints (2), (3), (5), or (6), to the original portfolio construction strategy, and then varying the parameter over a range of values.

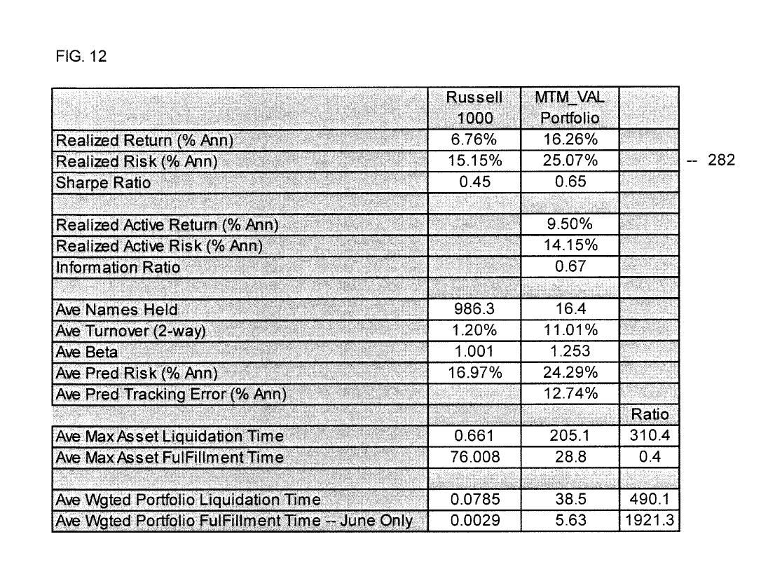

Table 282 in FIG. 12 shows summary statistics from the initial backtest for the second case study. The Sharpe ratio is 0.65 versus the benchmark Sharpe ratio of 0.45, and the value-momentum portfolio easily out-performs the benchmark, albeit with considerably more risk than in the case of the minimum risk portfolio in the first case study. Note that the average number of names is only 16.4, which is quite small. In this example, it might be desirable to increase the number of names through a liquidity constraint. Three of the liquidity ratios relative to the benchmark are 310, 490, and 1921, each of which is larger than the previous case, indicating that this portfolio may have even more illiquid positions than the minimum risk portfolio.

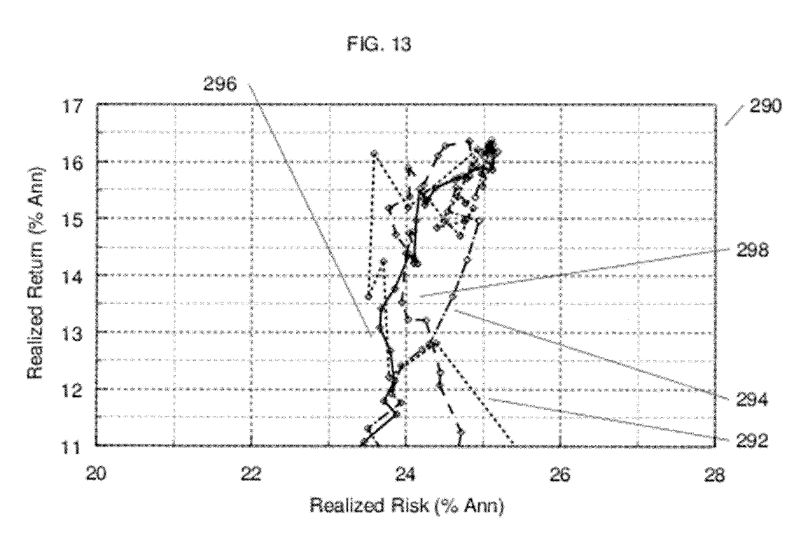

Chart 290 in FIG. 13 shows the traditional efficient frontier parameters, realized return and risk, for each of the four constraints: ADV_{MIN} is shown by the dotted curve 292; A. is shown by the dash-dot line 294; β is shown by the solid line 296; and γ is shown by the dashed line 298. All four liquidity constraints reduce the realized return with almost no change in the realized risk. For this second case study, the initial backtest achieves high return by investing in illiquid names that may not be able to deliver such returns in practice due to high trading costs. Once again, there is a negative relationship between liquidity and performance: the more liquid the portfolio, the less the realized return.

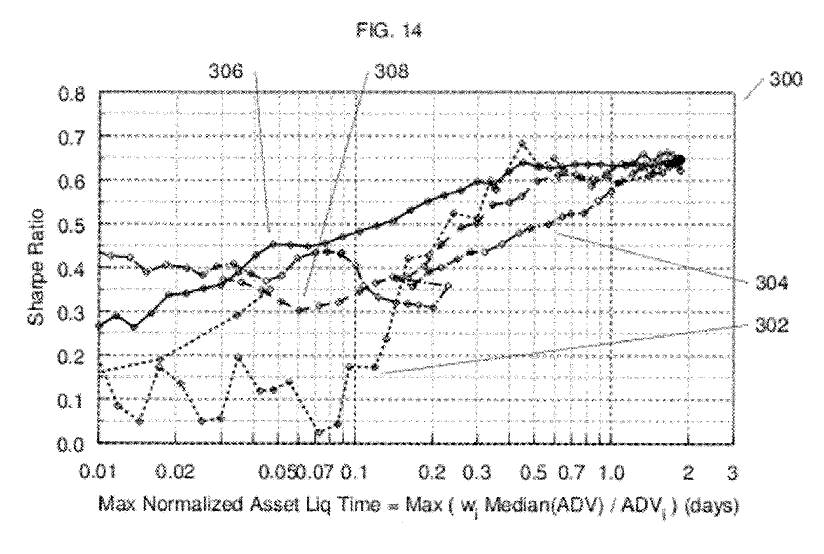

Chart 300 in FIG. 14 shows the Sharpe ratio plotted against the maximum, normalized, asset liquidation time, (wᵢ Median(ADV))/(ADVᵢ), for each of the four constraints: ADV_{MIN} is shown by the dotted curve 302; λ is shown by the dash-dot line 304; β is shown by the solid line 306; and γ is shown by the dashed line 308. As before, the highest Sharpe ratios occur when using β, and the second highest occur when using γ. Both curves 306 and 308 show smoothly decreasing Sharpe ratio with increasing asset liquidity and decreasing liquidation time.

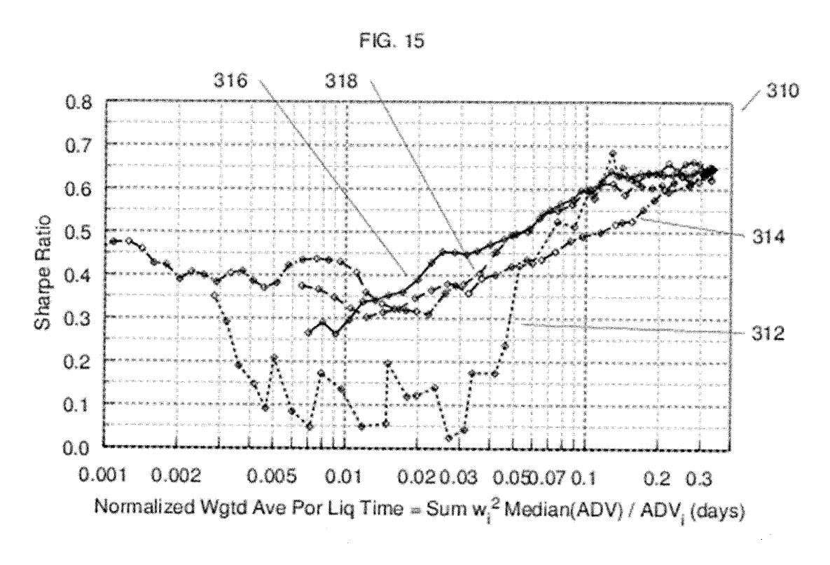

Chart 310 in FIG. 15 shows the Sharpe ratio plotted against the normalized, weighted average portfolio liquidation time,

$${\sum }_{i = 1}^{K} {w}_{i}^{2} Median ( ADV ) / {ADV}_{i} ,$$

for each of the four constraints: ADV_{MIN} is shown by the dotted curve 312; λ is shown by the dash-dot line 314; β is shown by the solid line 316; and γ is shown by the dashed line 318. Once again, the results for β and γ are virtually indistinguishable. Sharpe ratio decreases as portfolio liquidation time decreases.

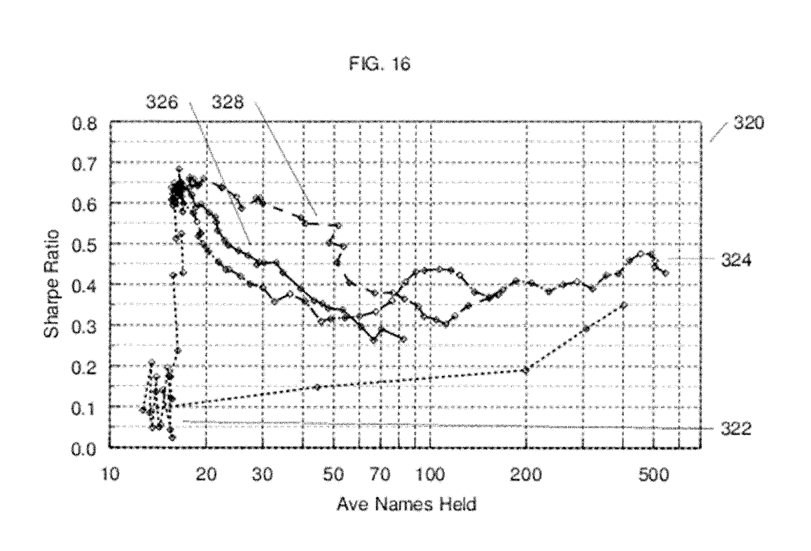

Chart 320 in FIG. 16 shows the Sharpe ratio plotted against the average number of names held for each of the four constraints: ADV_{MIN} is shown by the dotted curve 322; λ is shown by the dash-dot line 324; β is shown by the solid line 326; and γ is shown by the dashed line 328. For this second case study, the γ constraint has the least decrease in the Sharpe ratio with the most increase in names. For example, curve 328 shows that γ can hold, on average, 50 names while retaining a Sharpe ratio of 0.55. Curve 326 shows that when β holds 50 names, the Sharpe ratio drops to 0.35. This is a substantial difference and highlights the advantage of the γ constraint over the β constraint for this case study.

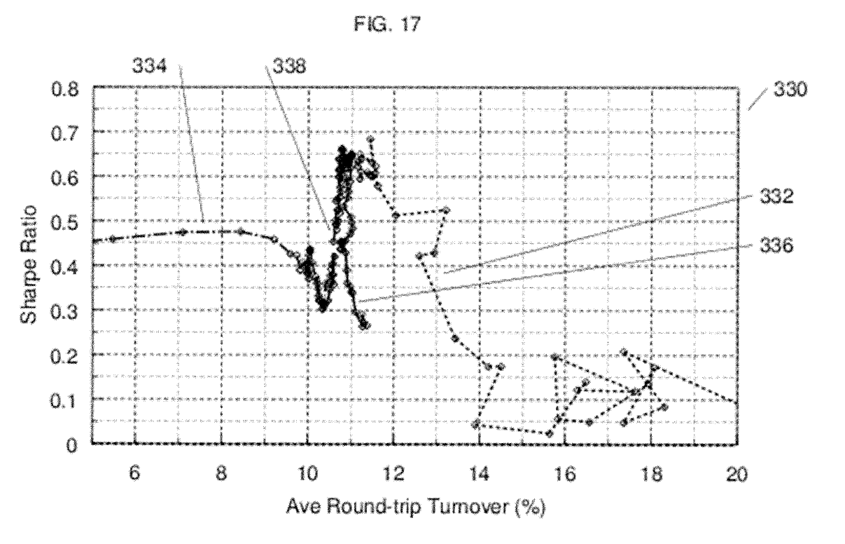

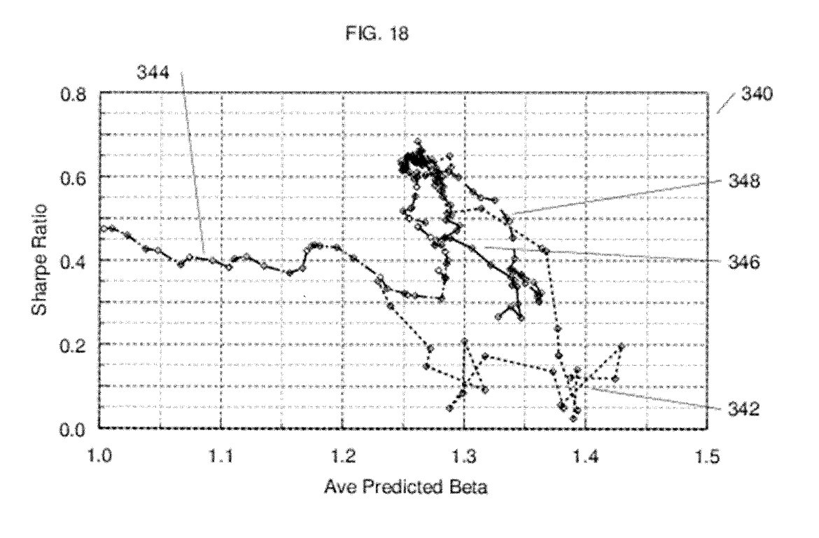

Chart 330 in FIG. 17 shows the Sharpe ratio plotted against the average two-way turnover for each of the four constraints: ADV_{MIN} is shown by the dotted curve 332; λ is shown by the dash-dot line 334; β is shown by the solid line 336; and γ is shown by the dashed line 338. For this second case study, the average turnover changes very little as the constraints become more binding. For most of the curves, turnover is between 10% and 11%. Finally, chart 340 in FIG. 18 shows the Sharpe ratio plotted against average predicted beta by Axioma medium horizon, fundamental factor U.S. equity risk model, AXUS3-MH, for each of the four constraints: ADV_{MIN} is shown by the dotted curve 342; λ is shown by the dash-dot line 344; β is shown by the solid line 346; and γ is shown by the dashed line 348. For the β and γ constraints, predicted beta increases slightly from 1.25 to a little over 1.3 as the constraints become more binding and increase liquidity of the portfolio.

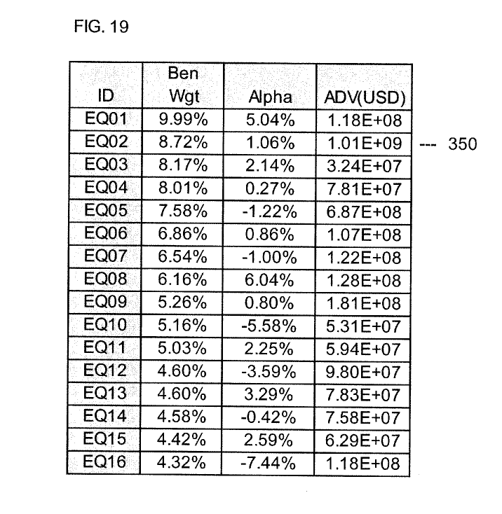

Next, the present invention is illustrated using a very simple, explicit example. Table 350 in FIG. 19 shows data for a universe of 16 assets. The assets are named EQ01, EQ02, . . . , EQ16, and could represent equities, or other investment opportunities. Each of the 16 assets is assigned a benchmark weight, an alpha score, and an ADV value in U.S. dollars. The sum of the benchmark weights is 100%.

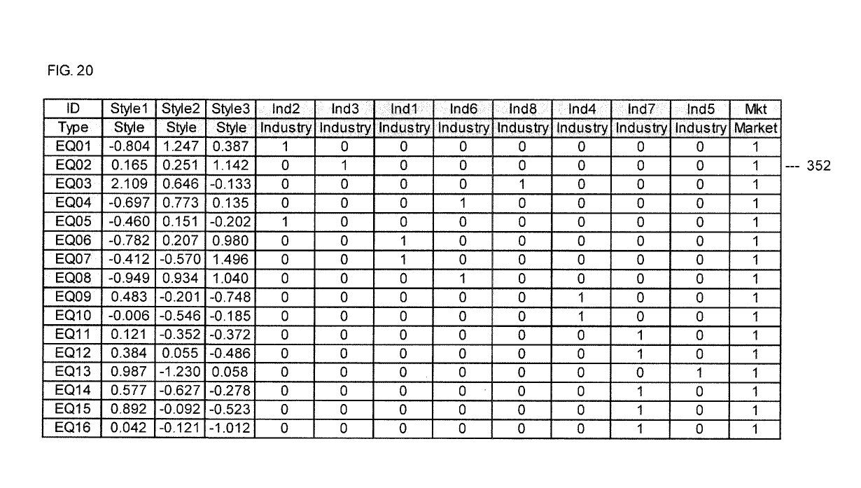

A factor risk model is associated with the investment universe of table 350. Table 352 in FIG. 20 illustrates the exposure matrix for the 16 assets. The factor risk model has 12 factors: three style factors, labelled “Style1”, “Style2”, and “Style3”; eight industry factors, which are binary; and one market factor named “Mkt”.

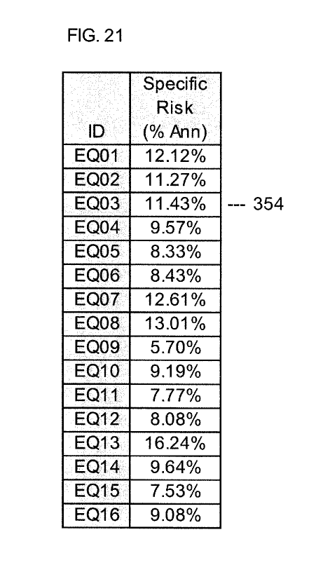

Table 354 in FIG. 21 gives the specific risk for each of the sixteen assets, measured in percent annual volatility.

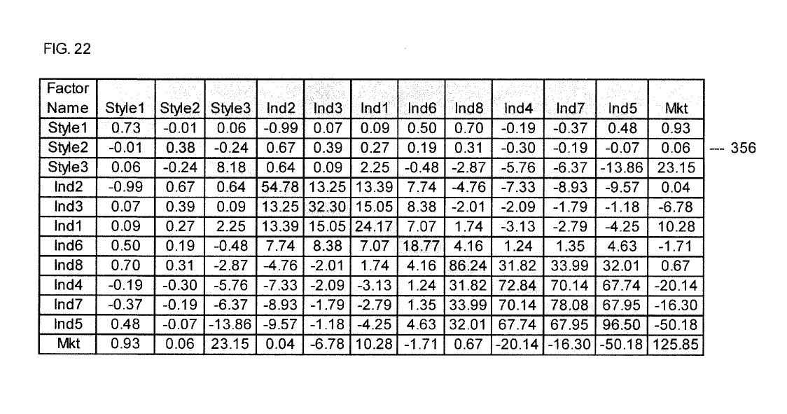

Table 356 in FIG. 22 gives the factor-factor covariance matrix for the twelve original factors. The values are given in units of percent annual variance squared for simplicity.

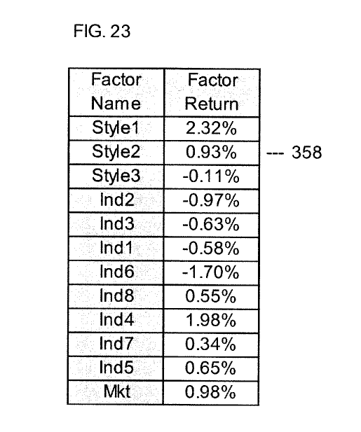

Table 358 in FIG. 23 gives the factor return, in units of percent, for the twelve factors.

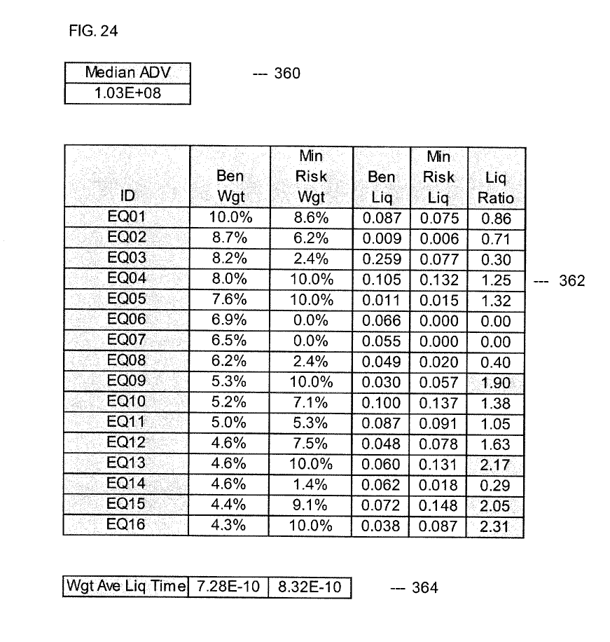

Tables 360, 362 and 364 in FIG. 24 give a summary of the results of replicating the portfolio construction strategy of the first case study without liquidity rules and without any turnover constraint on this simple, 16 asset example. For the optimal weights, listed as “Min Risk Wgt” in table 362, the risk predicted by the factor risk model described in 352, 354, 356, and 358 is minimized There are five assets (EQ04, EQ05, EQ09, EQ13, and EQ16) with the maximum allowable asset allocation of 10%. Table 362 also lists the normalized liquidity of the benchmark and minimum risk portfolio holdings. The column headed “Ben Liq” lists (bᵢ Median (ADV)/ADVᵢ), the normalized asset liquidation time of the benchmark positions, where the median ADV is shown in table 360 as $103 MM. The column headed “Min Risk Liq” lists (wᵢ Median (ADV)/ADVᵢ), the normalized asset liquidation time for the portfolio positions. The ratio of the minimum risk liquidation time to the benchmark liquidation time is given in the last column of table 362 labelled “Liq Ratio”. The three largest ratios are highlighted in grey, and have values of 2.31 (EQ16), 2.17 (EQ13), 2.05 (EQ15), and 1.90 (EQ09). Note that in this simple example, these ratios are smaller than those of the case studies where the ratios could be greater than ten or one hundred. This is an artifact of the fact that there are so few assets and the range of ADV.

Table 364 lists the weighted average, normalized liquidation time for the benchmark (7.28×10⁻¹⁰) and the minimum risk portfolio (8.32×10⁻¹⁰). As with the asset liquidation time ratios, this ratio is relatively small compared to the real world case studies. Nevertheless, tables 362 and 364 provide evidence that the minimum risk portfolio is less liquid than the benchmark.

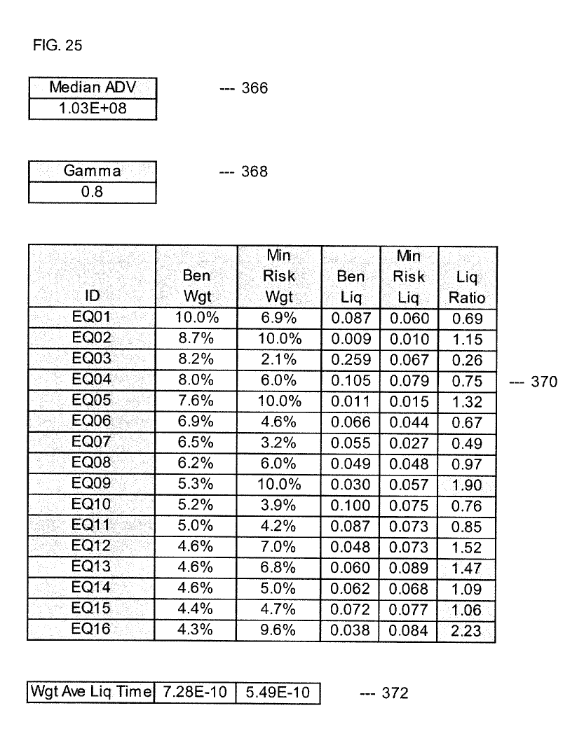

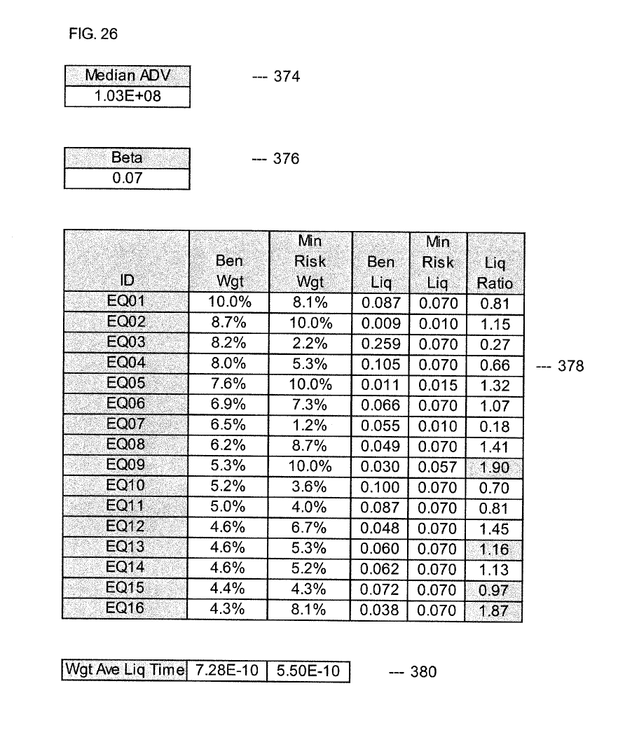

In tables 366, 368, 370, and 372 in FIG. 25, similar results are presented using γ=0.8. In tables 374, 376, 378, and 380 in FIG. 26, corresponding results are presented using β=0.07. These two parameters are chosen so that they produce the same weighted average liquidation times, namely 5.5×10⁻¹⁰, as shown in tables 372 and 380. Hence, the two constraints have reduced the weighted average liquidation time by about 34%. This is one improvement in the liquidity of the portfolio.

A different comparison of liquidity is shown in the ratio of asset liquidation times in tables 370 and 378. For the γ constraint, the maximum ratio is 2.23 (EQ16), which is less than the maximum of table 362 (2.31). This result represents a slight improvement in liquidity. For the β constraint, the maximum asset liquidation ratio has been reduced even further to 1.90 for a different asset (EQ09). Note that in the “Min Risk Liq” column for the β constraint, thirteen assets achieve the maximum allowable value of 0.070. The other three assets report liquidations times of less than that limit. This is typical of an asset level constraint such as (5) in that the constraint is only binding for a subset of the assets in the investment universe. So, in this example, both the γ and β constraints improve liquidity. By at least one measure, asset liquidity, β improves liquidity more than γ.

FIG. 27 shows a flow diagram illustrating the steps of process 2700 embodying the present invention as applied to the construction of a portfolio of investment allocations. In step 2702, a universe of potential investments is defined.

In step 2704, a measure of trading liquidity such as ADV is obtained for each potential investment. This measure can be utilized to identify assets than may pose liquidity problems.

In step 2706, a subset of illiquid assets from the universe of potential investment is identified.

In step 2708, a set of benchmark weights is obtained.

In step 2710, supporting data is obtained on the universe of potential investments. This data may include factor risk models, alpha signals, and transaction costs, and so forth.

In step 2712, a set of rules for constructing a portfolio of investments allocations or percentage weights that include the constraint that the weighted average liquidation time of the portfolio is less than a constant times the benchmark weighted average liquidation time. This is a description of the constraint (6) above utilizing ADV as the measure of trading liquidity.

In step 2714, the portfolio of investment allocations is determined that best satisfies the objectives and constraints of the portfolio construction rules.

Finally, in step 2716, the best investment allocation is output. This allocation may be output in the form of a published index or ETF.

FIG. 28 shows a second flow diagram illustrating the steps of a process 2800 embodying the present invention as applied to the construction of a portfolio of investment allocations.

In step 2802, a universe of potential investments is defined.

In step 2804, a measure of trading liquidity such as ADV is obtained for each potential investment. This measure can be utilized to identify assets that may pose liquidity problems.

In step 2806, a subset of illiquid assets from the universe of potential investment is identified.

In step 2808, supporting data is obtained on the universe of potential investments. This data may include factor risk models, alpha signals, and transaction costs, and so forth.

In step 2810, a set of rules for constructing a portfolio of investments allocations or percentage weights that include the constraint that the ratio of the percentage weight over the measure of trading liquidity for each asset in the subset of illiquid assets is the same. This is a description of the constraint (5) above utilizing ADV as the measure of trading liquidity.

In step 2812, the portfolio of investment allocations is determined that best satisfies the objectives and constraints of the portfolio construction rules.

Finally, in step 2814, the best investment allocation is output. This allocation may be output in the form of a published index or ETF.

While the present invention has been disclosed in the context of various aspects of presently preferred embodiments, it will be recognized that the invention may be suitably applied to other environments consistent with the claims which follow.

We claim:

1. A computer-implemented method for constructing a portfolio of investment assets comprising:
electronically receiving by a programmed computer a set of N potential investments having a range of liquidities;
electronically receiving by the programmed computer an N-dimensional vector giving a measure of the trading liquidity for each of the possible investments;
electronically receiving by the programmed computer an N-dimensional vector giving percentage weights for a benchmark portfolio of investment assets;
electronically receiving by a programmed computer a subset of illiquid assets from the potential investments;
calculating on the programmed computer a portfolio of assets with percentage weights, wherein a sum over the subset of illiquid assets of ratios of each percentage weight of the asset in the portfolio squared over the measure of trading liquidity is less than or equal to a constant value times a sum over the subset of illiquid assets of ratios of each percentage weight of the asset in the benchmark portfolio squared over the measure of trading liquidity wherein the constant value is independent of a number of shares or a currency amount invested in each potential investment;
electronically outputting the portfolio employing an output device.

2. The method of claim 1 where the measure of the trading liquidity is a measure of average daily volume.

3. The method of claim 2 where the constant value takes a value between 5×10⁻¹ and 1×10³.

4. The method of claim 3 where the portfolio to be determined is a factor index wherein the risk of the portfolio is minimized or the exposure of the portfolio to a factor is maximized.

5. The method of claim 4 wherein the factor exposure is a measure of dividend yield, exchange rate sensitivity, growth, leverage, liquidity, market sensitivity or beta, momentum, return on equity, size or market capitalization, value, or volatility.

6. A computer-implemented method for constructing a portfolio of investment assets comprising:
electronically receiving by a programmed computer a set of N potential investments having a range of liquidities;
electronically receiving by the programmed computer an N-dimensional vector giving a measure of the trading liquidity for each of the possible investments;
electronically receiving by the programmed computer an N-dimensional vector giving percentage weights for a benchmark portfolio of investment assets;
electronically receiving by a programmed computer a subset of illiquid assets from the potential investments;
calculating on the programmed computer a portfolio of assets with percentage weights, wherein a sum over the subset of illiquid assets of ratios of each percentage weight of the asset in the portfolio times each percentage weight traded in the asset in the portfolio over the measure of trading liquidity is less than or equal to a constant value times a sum over the subset of illiquid assets of ratios of the percentage weight of each asset in the benchmark portfolio squared over the measure of trading liquidity wherein the constant value is independent of a number of shares or a currency amount invested in each potential investment;
electronically outputting the optimized portfolio employing an output device.

7. The method of claim 6 where the measure of the trading liquidity is a measure of average daily volume.

8. The method of claim 7 where the constant value takes a value between 5×10⁻¹ and 1×10³.

9. The method of claim 8 where the portfolio to be determined is a factor index wherein the risk of the portfolio is minimized or the exposure of the portfolio to a factor is maximized.

10. The method of claim 9 wherein the factor exposure is a measure of dividend yield, exchange rate sensitivity, growth, leverage, liquidity, market sensitivity or beta, momentum, return on equity, size or market capitalization, value, or volatility.

11. A computer-implemented method for constructing a portfolio of investment assets comprising:
electronically receiving by a programmed computer a set of N potential investments having a range of liquidities;
electronically receiving by the programmed computer an N-dimensional vector giving a measure of the trading liquidity for each of the possible investments;
electronically receiving by a programmed computer a subset of illiquid assets from the potential investments;
calculating on the programmed computer a portfolio of assets with percentage weights, wherein the ratio of each percentage weight of the asset in the portfolio over the measure of trading liquidity is the same value for each asset in the subset of illiquid assets where the value is independent of a number of shares or a currency amount invested in each potential investment; and
electronically outputting the optimized portfolio employing an output device.

12. The method of claim 11 where the value of the ratio equals a constant divided by the median value of the measure of the trading liquidity.

13. The method of claim 12 where the constant value takes a value between 10⁻⁴ and 10¹.

14. The method of claim 11 where the measure of the trading liquidity is a measure of average daily volume.

15. The method of claim 14 where the portfolio to be determined is a factor index wherein the risk of the portfolio is minimized or the exposure of the portfolio to a factor is maximized.

16. The method of claim 15 wherein the factor exposure is a measure of dividend yield, exchange rate sensitivity, growth, leverage, liquidity, market sensitivity or beta, momentum, return on equity, size or market capitalization, value, or volatility.

17. A computer-implemented method for constructing a portfolio of investment assets comprising:
electronically receiving by a programmed computer a set of N potential investments having a range of liquidities;
electronically receiving by the programmed computer an N-dimensional vector giving a measure of the trading liquidity for each of the possible investments;
electronically receiving by a programmed computer a subset of illiquid assets from the potential investments;
calculating on the programmed computer a portfolio of assets with percentage weights, wherein the ratio of each percentage weight traded in the asset in the portfolio over the measure of trading liquidity is the same value for each asset in the subset of illiquid assets where the value is independent of a number of shares or a currency amount invested in each potential investment; and
electronically outputting the optimized portfolio employing an output device.

18. The method of claim 17 where the value of the ratio equals a constant divided by the median value of the measure of the trading liquidity.

19. The method of claim 18 where the constant value takes a value between 10⁻⁴ and 10¹.

20. The method of claim 17 where the measure of the trading liquidity is a measure of average daily volume.

21. The method of claim 20 where the portfolio to be determined is a factor index wherein the risk of the portfolio is minimized or the exposure of the portfolio to a factor is maximized.

22. The method of claim 21 wherein the factor exposure is a measure of dividend yield, exchange rate sensitivity, growth, leverage, liquidity, market sensitivity or beta, momentum, return on equity, size or market capitalization, value, or volatility.

23. A computer-implemented method for constructing a portfolio of investment assets comprising:
electronically receiving by a programmed computer a set of N potential investments having a range of liquidities;
electronically receiving by the programmed computer an N-dimensional vector giving a measure of the trading liquidity for each of the possible investments;
electronically receiving by the programmed computer an N-dimensional vector giving percentage weights for a benchmark index of investment assets; determining on the programmed computer a first low liquidity, possibly empty subset of the N potential investments having a liquidity less than a predetermined low liquidity;
determining a second high liquidity, possibly empty subset of the N potential investments having a liquidity greater than a predetermined high liquidity;
determining a central range subset of the N potential investments having liquidities between the low predetermined liquidity and the high predetermined liquidity;
calculating a portfolio on the programmed computer in which the percentage weight of each investment in the central range subset of investments is determined by a liquidity constraint; and
electronically outputting the portfolio employing an output device.

24. The method of claim 23 wherein the low liquidity subset of the N potential investments is excluded from the portfolio.

25. The method of claim 24 where the percentage holdings of each of the high liquidity subsets are limited to a maximum value in an optimized portfolio.

26. The method of claim 23 wherein the liquidity constraint results in a portfolio of percentage weights for the portfolio of assets wherein a sum over the central subset of assets of ratios of the percentage weight of the portfolio squared over the measure of trading liquidity is less than or equal to a constant value times a sum over the central subset of assets of ratios of the percentage weight of the benchmark portfolio squared over the measure of trading liquidity wherein the constant value is independent of a number of shares or a currency invested in each potential investment.

27. The method of claim 26 wherein the liquidity constant is defined in terms of the constant value γ such that
$${\sum }_{i = 1}^{K} ( \frac{{w}_{i}^{2}}{{ADV}_{i}} ) \leq γ {\sum }_{i = 1}^{K} ( \frac{{b}_{i}^{2}}{{ADV}_{i}} ) .$$

28. The method of claim 27 wherein 5×10⁻¹<γ<1×10³.

29. The method of claim 28 wherein 2<γ<15.

30. The method of claim 23 wherein liquidity constraint is defined in terms of β such that
$$\frac{{w}_{i}}{{ADV}_{i}} \leq \frac{β}{Median ( ADV )} ,$$
i=1, . . . , K.

31. The method of claim 30 wherein 10⁻⁴<β<10¹.

32. The method of claim 31 wherein 10⁻³<β<10⁻¹.
